(19) United States
(12) Patent Application Publication
(10) Pub. No.: US 2008/0186319 A1
(43) Pub. Date: Aug. 7, 2008

(54) Dynamically activated frame buffer

(75) Inventor: Alon Boner, Netanya (IL)

Correspondence Address: BROWDY AND NEIMARK, P.L.L.C.;624 NINTH STREET, NW, SUITE 300, WASHINGTON, DC, 20001-5303, US

(73) Assignee: D.S.P. Group Ltd., Herzliya (IL)

(21) Appl. No.: 11/702,215

(22) Filed: Feb. 5, 2007

(51) Int. Cl. G09G 5/36

(52) U.S. Cl. 345/545

(57) ABSTRACT

Methods and systems for storing or not storing images in a frame buffer during the provision of images to a screen. In one embodiment, the selective usage of the frame buffer may lead to a reduction in power consumption.

### FIELD OF THE INVENTION

This invention relates to the field of image display and particularly to frame buffer usage.

### BACKGROUND OF THE INVENTION

When an image source provides an image for display, the image often undergoes processing prior to being displayed on a screen. For example, the image displayed on a screen may have been mixed from a plurality of images, each provided by a different image source.

In the related art, the processing of images from at least one source may be performed on the fly, with the resulting generated image stream sent directly to the screen. For example, typically although not necessarily in a television set, the processing is performed on the fly because it is assumed that the received broadcast is constantly changing at the display rate of the television set.

Instead in the related art, the resulting generated image stream may always be written to a frame buffer, and from there read by a display controller prior to being displayed on the screen. This solution is common in personal computers and other devices in which the image on the screen or large parts of the image on the screen do not change for long periods of time.

### SUMMARY OF THE INVENTION

According to the present invention, there is provided a method of selectively using a frame buffer, comprising: processing at least part of at least one image from at least one source, yielding a processed image; and storing or not storing the processed image in a frame buffer, based on at least one consideration; wherein regardless of whether the processed image is stored or not stored in the frame buffer, the processed image or a function thereof is displayed on a screen.

According to the present invention, there is also provided a method of selectively using a frame buffer, comprising: monitoring at least one parameter affecting an outcome of an algorithm for determining whether or not a frame buffer is to be written to during provision of images to a screen; attempting to determine an outcome of the algorithm based on at least one value of the at least one monitored parameter; and deciding based on the algorithm conclusion or based on a default state for the frame buffer whether or not the frame buffer is to be written to during provision of images to the screen.

According to the present invention, there is further provided a system for selectively using a frame buffer, comprising: a frame buffer; an image processor configured to selectively write to the frame buffer during provision of images to a screen; and an image display controller configured to selectively read from the frame buffer, during provision of images to a screen.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram of a system with a dynamically activated frame buffer, according to an embodiment of the present invention;

FIG. 2 is a block diagram of a system with a dynamically activated frame buffer, according to another embodiment of the present invention;

FIG. 3 is a block diagram of a system with a dynamically activated frame buffer, according to another embodiment of the present invention;

FIG. 4 is a flowchart of method for configuring a frame buffer as active or inactive, according to an embodiment of the present invention; and

FIG. 5 (including FIG. 5A and FIG. 5B) is a flowchart of an algorithm for determining whether to configure a frame buffer as active or inactive, according to an embodiment of the present invention.

### DETAILED DESCRIPTION OF EXEMPLARY EMBODIMENTS

Described herein are embodiments of the current invention for dynamic activation of a frame buffer. In some embodiments of the invention, one or more images (and/or parts of images) from one or more sources are processed and the resulting processed image or a function thereof is displayed on a screen. In one of these embodiments, a decision is made whether or not to store the resulting processed image in a frame buffer. The term “function thereof” is used to include the possibility that in some of these embodiments, the image that is displayed is not necessarily identical to the resulting processed image.

As used herein, the phrase “for example,” “such as” and variants thereof describing exemplary implementations of the present invention are exemplary in nature and not limiting.

Reference in the specification to “one embodiment”, “an embodiment”, “some embodiments”, “another embodiment”, “other embodiments” or variations thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” or variations thereof do not necessarily refer to the same embodiment(s).

The present invention is primarily disclosed as a method and it will be understood by a person of ordinary skill in the art that an apparatus such as a conventional data processor incorporated with a database, software and other appropriate components could be programmed or otherwise designed to facilitate the practice of the method of the invention.

Unless specifically stated otherwise, as apparent from the following discussions, it is appreciated that throughout the specification discussions, utilizing terms such as, “processing”, “computing”, “calculating”, “determining”, “applying”, “associating”, “providing”, or the like, refer to the action and/or processes of any combination of software, hardware and/or firmware. For example, in one embodiment a computer, processor or similar electronic computing system may manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as, element, processor, device, system, computer, apparatus, system, sub-system, module, unit, etc, (in single or plural form) for performing the operations herein. These terms, as appropriate, refer to any combination of software, hardware and/or firmware configured to perform the operations as defined and explained herein. The module(s) (or counterpart terms specified above) may be specially constructed for the desired purposes, or it may comprise a general purpose programmable machine selectively activated or reconfigured by a program stored in the programmable machine. Such a program may be stored in a readable storage medium, such as, but not limited to, any type of disk including optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, any other type of media suitable for storing electronic instructions that are capable of being conveyed, for example via a computer system bus.

The method(s)/processe(s)/module(s) (or counterpart terms for example as specified above) and display(s) presented herein are not inherently related to any particular system or other apparatus, unless specifically stated otherwise. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

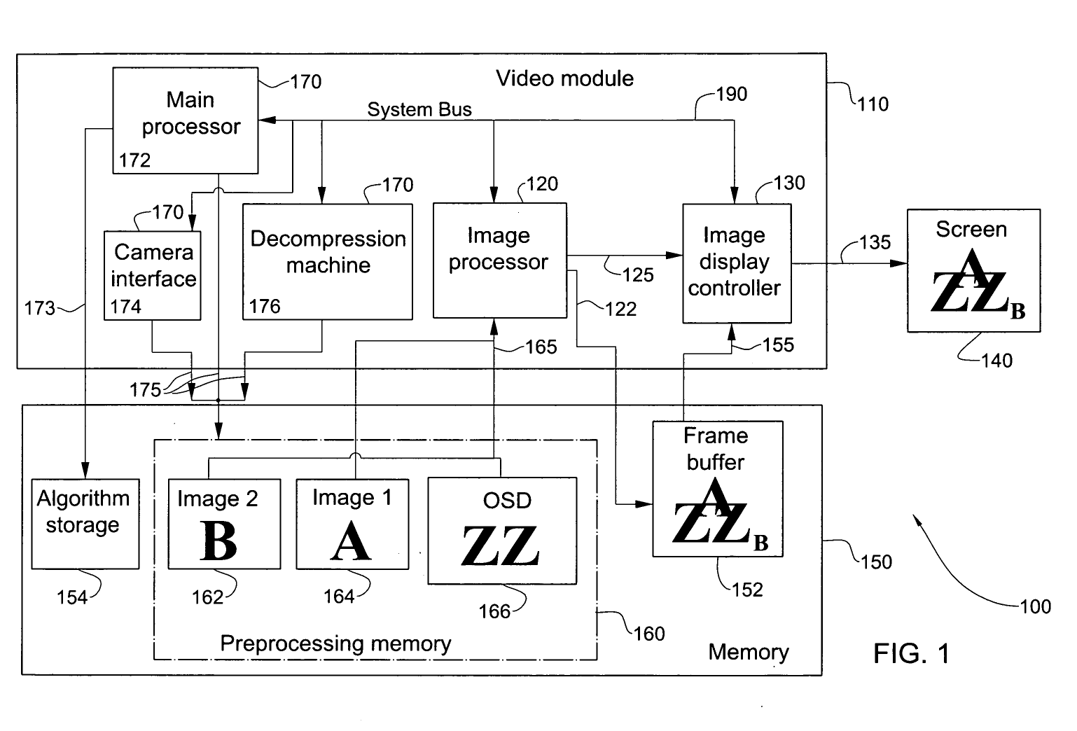

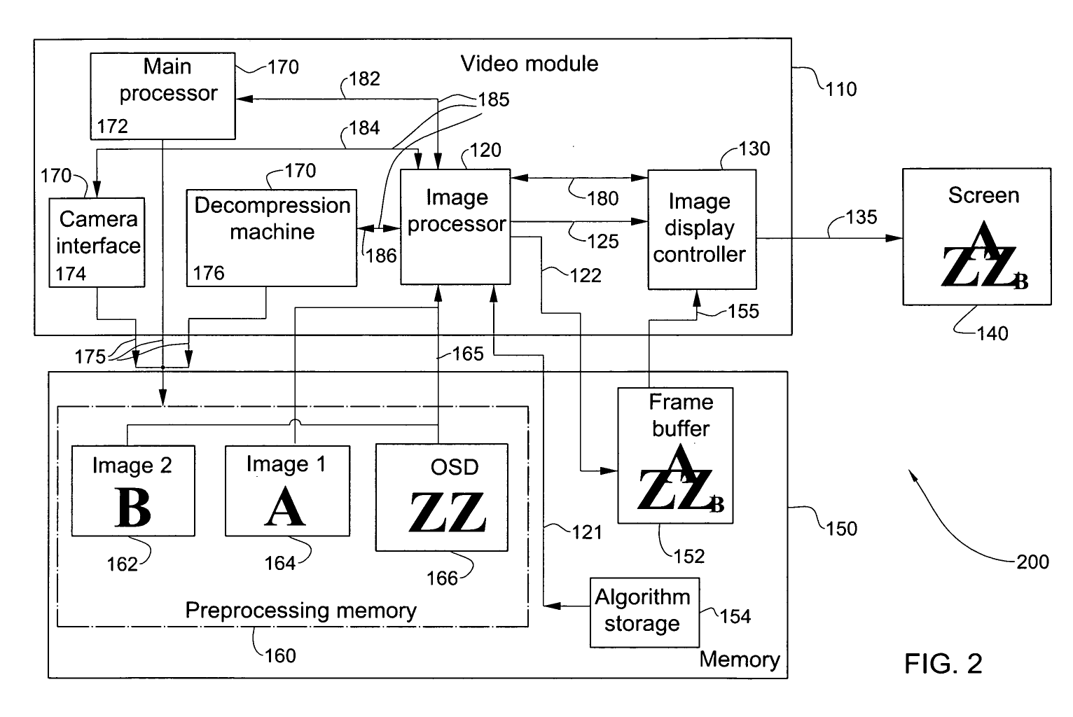

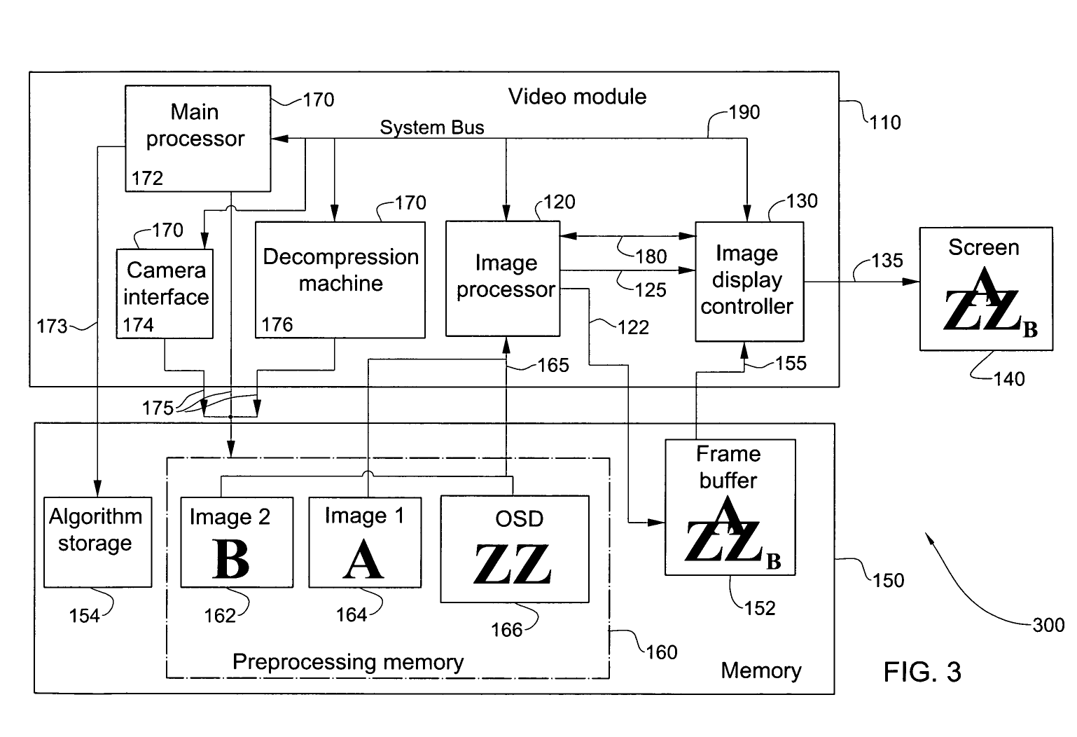

FIG. 1 is a block diagram of a configuration 100 including dynamic frame buffer activation, according to an embodiment of the present invention. FIG. 2 is a block diagram of a configuration 200 including dynamic frame buffer activation, according to another embodiment of the present invention. FIG. 3 is a block diagram of a configuration 300 including dynamic frame buffer activation, according to another embodiment of the present invention. As FIG. 1, FIG. 2, and FIG. 3 share many elements in common, the common elements will be discussed first. As illustrated in FIG. 1, FIG. 2, or FIG. 3, configuration 100, 200, or 300 respectively includes one or more screens 140 configured to display images, a video module 110 configured to handle images prior to display, and one or more memories 150 configured to store images. An image typically although not necessarily refers to a picture (also referred to as graphics or video) which may optionally include text.

In one embodiment, configuration 100, 200, or 300 may be included in or comprise any electronic system which includes one or more screens 140. For example configuration 100 may be included in a cellular telephone, a computer (e.g. computer system, computer network, laptop computer, etc), a personal digital assistant PDA, a television, a cordless phone, a personal media player, an MPx (x=any number) player, any handheld and/or device including screen(s), etc. As evident from the above examples, depending on the embodiment, screen(s) 140 in configuration 100, 200 or 300 may be integrated in the same physical unit with video module 110 and/or memory/ies 150, or screen(s) 140 may be located in a separate physical unit from video module and/or memory/ies 150, communicating for example via any appropriate wired or wireless connection. Furthermore, screen(s) 140, video module 110 and/or memory/ies 150 may be centralized in one location or dispersed over more than one location depending on the embodiment. For example in one embodiment video module 110 is included on one chip and memory/ies 150 is/are included on separate chip(s).

Each of modules 110, 140, and 150 (illustrated in FIG. 1, 2, or 3 as being comprised in configuration 100, 200 or 300 respectively) may be made up of any combination of software, hardware and/or firmware that performs the functions as defined and explained herein. In other embodiments of the invention, configuration 100 200, or 300 may comprise fewer, more and/or different modules than those shown in FIG. 1, 2, or 3 respectively. In other embodiments of the invention, the functionality of configuration 100, 200, or 300 described herein may be divided differently among the modules of FIG. 1, 2, or 3 respectively, and/or configuration 100, 200, or 300 may include additional or less functionality than described herein. In other embodiments of the invention, one or more of modules 100, 140 and/or 150 may have more, less and/or different functionality than described herein.

Depending on the embodiment, any number of screens 140 configured to display images may be included in configuration 100. The included screen(s) may be of the same type (i.e. having the same characteristics) or may be of different types. For example, in one embodiment, each of screen(s) 140 may or may not have an associated display controller and an associated frame buffer, whereas in another embodiment, there is at least one screen 140 with an associated display controller and an associated frame buffer and at least one screen 140 without an associated display controller and without an associated frame buffer. The terms “associated display controller” and “associated frame buffer” refer to a display controller and/or frame buffer in the same physical unit as screen 140 and/or connected between video module 110 and screen 140 so that an image outputted from video module 110 is transferred to the associated display controller and/or stored in the associated frame buffer prior to the display of the outputted image or a function thereof on screen 140. In one embodiment, the image that is outputted from video module 110 is displayed, whereas in another embodiment, the associated display controller adapts the outputted image so that a function of the outputted image is displayed.

In some embodiments, only one screen 140 at a time can receive an image outputted from video module 110 (assuming video module 110 includes only one image display controller 130 to be described further below). In one of these embodiments, at least two screens 140 are included in configuration 100 but only one of the included screens 140 at a time can receive the outputted image. In another of these embodiments, one screen 140 is included in configuration 100 but the type of included screen 140 (i.e. one or more characteristics of included screen 140) may differ, depending on the embodiment. For simplicity of description, the single form of screen 140 is used below to include both embodiments with a single and a plurality of screens. Screen 140 used in configuration 100 may comprise any suitable screen known in the art, for example a Cathode Ray Tube (CRT) monitor, a Liquid Crystal Display (LCD) panel, LCD-TFT (Thin Film Transistor), LCD-STN (Super Twisted Nematic), organic light emitting diode OLED or any other technology.

As illustrated in FIG. 1, 2, or 3 video module 110 includes one or more image source(s) 170, one or more image processor(s) 120 and one or more image display controller(s) 130. For simplicity of description the plural form of image sources 170 is used below to include both embodiments with a single source and a plurality of sources. Image sources 170 are configured to provide images. Depending on the embodiment, image sources 170 may provide images by generating the images and/or by receiving the images from outside of video module 110. For example, images sources 170 may include any of the following inter-alia: camera interface(s) 174 (receiving live images from one or more cameras external to video module 110), interface(s) to pre-recorded video streams (for example from DVD player(s), videocassette recorder(s) VCR(s), etc), decompression machine(s) 176 (for example DVD decoder core(s), MPEG1, MPEG2, MPEG4, etc, decoder core(s), video generator(s), video decoder core(s)) main processor 172, other processors, interface(s) to external decompression machine(s), etc. Main processor 172 (and/or other processor(s)) may generate images for example corresponding to one or more currently running applications (e.g. word processor, game software, web browser, etc) and/or for example based on user input (through any user interface such as remote control, keyboard, mouse, touch screen, dials, buttons, etc). The invention is not limited to certain types and/or to a certain number of sources 170, which may vary depending on the embodiment. It should also be understood that in some embodiments, one or more sources 170 in configuration 100 may not always provide images. For example, in one of these embodiments, if there are “n” sources 170 which are capable of providing images in configuration 100, at any point in time any number of sources 170 from 0 to “n” sources may be actually providing images.

For simplicity of description the single form is used below for image processor 120 to include both embodiments with a single image processor 120 and with a plurality of image processors 120, and the single form is used below for image display controller 130 to include both embodiments with a single image display controller 130 and with a plurality of image display controllers 130 (for example when there is a plurality of screens 140). Image processor 120 is configured to process images and/or parts of images provided by image sources 170, generating a processed image and the processed image or a function thereof is directly and/or indirectly provided to image display controller 120. In one embodiment, each processed image is generated at an appropriate time as will be discussed in more detail below. The type(s) of processing performed by image processor 120 on images provided by image sources 170 in order to generate the processed image are not limited by the invention. For example depending on the embodiment, image processor 120 may perform any of the following operations, inter-alia on an image: mixing a plurality of images to generate a single image (wherein the plurality of images that are mixed may in some cases be of differing size and/or format, or of the same size and/or format), filtering an image, substituting an image for another image, comparing images, identifying an image, changing the color of any image, changing the format of an image, resizing an image, rotating an image, mirroring an image, any combination of the above operations, any other operation involving a single or a plurality of images, etc. In some embodiments, image display controller 130 is configured to output each processed image or a function thereof from video module 110 at an appropriate time (as illustrated by line 135) as will be discussed in more detail below. In one of these embodiments, display controller 130 adapts the processed image (or the function thereof which is directly or indirectly provided to display controller 130), thereby outputting a function of the processed image. In one embodiment, both the functionality of image processor 120 and the functionality of image display controller 130 are performed by a single processor (for example with an internal sub-division) which may or may not be the same processor as main processor 172. In another embodiment, the functionality of image processor 120 is separate from the functionality of image display controller 130.

As mentioned above, display controller 130 and/or an associated display controller may adapt an image provided respectively to display controller and/or associated display controller. For example the adaptation may be to fit the image to a certain size of screen 140, to conform the format of the image to the type of screen 140 (for example TV, LCD-STN, LCD-TFT), and/or to conform the image to the quality/number of colors of screen 140 (for example, 16 bit or 18 bit)

Memory/ies 150 may comprise any suitable volatile or non-volatile type(s) of memory with write ability. For example, in one embodiment memory/ies 150 may comprise one or more random access memory RAM bank(s) such as but not limited to, dynamic random access memory (DRAM) bank(s), static random access memory/ies (SRAM) bank(s), single data rate (SDR) bank(s) double data rate dynamic random access memory (DDR SDRAM) bank(s), Rambus dynamic random access memory (RDRAM) bank(s), graphic dynamic random access memory (GDRAM) bank(s), or non volatile memories such as but not limited to flash memory bank(s), and/or magnetoresistive random access memory (MRAM) banks, etc. For simplicity of description, memory 150 is described herein below in the single form to include both embodiments with a single memory bank and a plurality of memory banks (of the same or differing types).

As illustrated in FIG. 1 2, or 3 memory 150 includes one or more “preprocessing” memory/ies 160 for storing images received from various image sources 170 in video module 110 prior to processing by image processor 120. For simplicity of description, it is assumed that preprocessing memory/ies 160 is used to store images from sources 170 and the single form of preprocessing memory 160 is used to include both embodiments with a single preprocessing memory and a plurality of pre-processing memories. In an embodiment where images from some or all of image sources 170 may sometimes or always be passed directly from those image source(s) to image processor 120 without first being stored in preprocessing memory/ies 160, similar methods and systems to those described herein may be used, mutatis mutandis. In one embodiment, each images source 170 is configured to write an image to pre-processing memory 160 at an appropriate time (illustrated by line 175), and image processor 120 is configured to read the images from preprocessing memory 160 (illustrated by line 165), at an appropriate time as will be explained in more detail below. For example, main processor 172 may function as an image source 170, writing graphics to an On Screen Display “OSD” memory location 166. Examples of such graphics include inter-alia: graphics indicating changes based on viewer input (for example via a remote control and/or any input device), closed captioning, subtitles, etc. (In other cases subtitles and/or closed captioning may be generated instead by another source 170, for example decompression machine 176). In the illustrated embodiment, there is a one-to-one correspondence between the number of illustrated sources 170 (i.e. 172, 174, and 176) and the number of memory locations (162, 164, and 166) in preprocessing memory 160, but in other embodiments the number of sources 170 may not match the number of available memory locations in preprocessing memory 160. For example in one of these other embodiments, main processor 172 may write to the same memory location in preprocessing memory 160 as another source 170, for example decompression machine 176, ensuring that each source 172 or 176 does not overwrite what the other source 176 or 172 has written. As another example in one of these other embodiments, a plurality of sources 170 which would not be providing images at the same time may share the same memory location in preprocessing memory 160. Continuing with the example, if a DVD decoder core and a video decoder core can-not work at the same time in configuration 100 in a particular embodiment, then the DVD decoder core and the video decoder core may in this embodiment share the same memory location in preprocessing memory 160. As another example, main processor 172 may write to a plurality of OSD memory locations 166 and/or any other image source 170 may write to a plurality of preprocessing memory locations in preprocessing memory 160.

As illustrated in FIG. 1 2, or 3 memory 150 also includes one or more (alternate) frame buffer(s) 152 for selectively storing processed images (after processing by image processor(s) 120). In one embodiment there may be two or more (alternate) frame buffers 152 storing images which will be consecutively displayed (or functions of which will be consecutively displayed) on screen 140, in order to reduce the probability that an image in the frame buffer is overwritten prior to being read by display controller 130. In this embodiment, one frame buffer 152 is written to by image processor 120 and the other (alternate) frame buffer 152 is read from by image display controller 130, and after each read is completed, the frame buffers switch functions. In another embodiment there may be one frame buffer 152 for storing processed images or a plurality of (alternate) frame buffers 152 for storing a plurality of processed images which will be consecutively displayed (or functions of which will be consecutively displayed) on screen 140.

Assume an embodiment where there is a plurality of display controllers 130, each reading an image. For example in some currently commercially available mid/high end PC graphic cards or on some cellular phones, a plurality of display controllers 130 may support a plurality of screens 140 in parallel. If the image read by a plurality of display controllers 130 is the same, the plurality of display controllers 130 may or may not share the same frame buffer 152 (or share a plurality of alternate frame buffers 152). If the read images differ, then in one embodiment, each different image is read from a different frame buffer.

For simplicity of description, the single form of frame buffer 152 is used to include both embodiments with a single frame buffer and a plurality of frame buffers.

In some cases a processed image generated by image processor 120 is stored in frame buffer 152 (illustrated by line 122) at an appropriate time and image display controller 130 reads the processed image from frame buffer 152 (illustrated by line 155) at an appropriate time as will be explained in more detail below. In other cases, a processed image is not stored in frame buffer 152 but the generated processed image is directly transferred to image display controller 130 (illustrated by line 125) at an appropriate time as will be explained in more detail below. In still other cases, the processed image is both stored in frame buffer 152 and directly transferred to image display controller 130. This latter “double” approach allows the benefit of storage in frame buffer 152 for subsequent accessing of the processed image but eliminates a read from the frame buffer 152 and consequent delay in the initial usage of the processed image as well as saving on the power which would have been required for an initial reading of the processed image from frame buffer 152.

As illustrated in FIG. 1, 2, or 3 memory 150 also optionally includes storage 154 related to the algorithm for deciding when to use or not use frame buffer 152. For example, in one embodiment storage 154 may include a look-up table generated by a developer as will be explained in more detail further below. Algorithm storage 154 is accessed by the module(s) in video module 110 which executes the algorithm (makes the decision). In FIGS. 1 and 3 it is assumed that main processor 172 executes the algorithm and therefore accesses algorithm storage 154 (illustrated as line 173). In FIG. 2 it is assumed that image processor 120 executes the algorithm and therefore accesses algorithm storage 154 (illustrated as line 121). In another embodiment, other module(s), for example image display controller 130, may access algorithm storage 154. In another embodiment, main processor 172, image processor 120, image display controller 130 or another module may execute the algorithm and therefore access algorithm storage 154 in any of configurations 100, 200, or 300. In another embodiment, a combination of any two or more of main processor 172, image processor 120, image display controller 130, and/or any other module(s) may access algorithm storage 154 in any of configurations 100, 200 or 300. In some embodiments the location of memory 154 may vary depending on which module(s) execute the algorithm.

In one embodiment of the invention there is a memory controller which controls access to (i.e. read from and/or write to) memory 150 and/or adapts the format of images for memory 150. Memory controllers are known in the art and will therefore not be elaborated upon here.

In FIG. 1 there is illustrated an embodiment with a system bus 190, where system bus 190 is used to transfer control indications which control the timing of transfer of images between any of various modules of configuration 100 (i.e. any of the transfers beginning with sources 170 and ending with screen 140), the usage/non-usage of frame buffer 152, and/or the timing of the processing of the images by image processor 120. In some embodiments with a system bus, control indications may originate from main processor 172 or from other modules in configuration 100. In one of these embodiments, a control indication originating from a particular module and destined for another module is coordinated by main processor 172. For example main processor 172 may read from the particular module and write to the other module. In another of these embodiments coordination by main processor 172 is not necessarily required. In some embodiments with system bus 190, system bus 190 may also be used to transfer images in system 100 (for example as illustrated by any lines 175, 165, 122, 155, 125 and/or 135 in FIG. 1), however in other embodiments, system bus 190 is not used for image transfer. In some embodiments with system bus 190, the power to different modules in system 100 is controlled by system bus 190.

In FIG. 2 there is illustrated an embodiment with direct connections (control channels) 182, 184, and 186 between image processor 120 and each of respective sources 172, 174, and 176 which are used to control the timing of transfer of images between any of various modules of configuration 200 (i.e. to control any of the transfers beginning with sources 170 and ending with screen 140), the usage/non-usage of frame buffer 152, and/or the timing of the processing of the images by image processor 120. (In this embodiment, if there are other sources 170 there would also be control channels between those other sources 170 and image processor 120). In the illustrated embodiment of FIG. 2, there is also a direct connection (control channel) 180 between image processor 120 and image display controller 130.

In other embodiments, there may be both a system bus 190 and any of control channels 180, 182, 184 and/or 186 (and/or control channels between image processor and any other sources 170). For example in some of these other embodiments, illustrated by configuration 300 in FIG. 3, there are both system bus 190 and control channel 180. In configuration 300, control indications which controls the timing of transfer of images between various modules of configuration 300 (i.e. any of the transfers beginning with sources 170 and ending with screen 140), the usage/non-usage of frame buffer 152, and/or the timing of the processing of the images by image processor 120 may be transferred via control channel 180 and/or via system bus 190. For example, in some embodiments of configuration 300, image processor 120 and image display controller 130 may or may not be able to transfer control indications to one another via system bus 190 in addition to being able to transfer control indications to one another via control channel 180.

Depending on the embodiment, configuration 100, 200 or a combination of system bus and one or more control channels such as for example in configuration 300, may be advantageous. For example in one embodiment a direct control channel optionally with limited control data types transferred over the direct control channel may in some cases be simpler than a system bus, for example with less hardware, less power, and/or simpler timing. As another example if between two modules there is both a system bus (with coordination via main processor 170) and a direct control channel, then in some cases more control data can be sent between the two modules.

For example, in one embodiment, control channel 180 and/or system bus 190 may be used for any of the following indications, inter-alia: display controller 130 requesting that image processor 120 generate a new processed image, image processor 120 notifying image display controller 130 that a new processed image is being prepared, image processor 120 or image display controller 130 passing a pointer to frame buffer 152 to the other module 130 or 120, display controller 130 signaling to image processor 120 to write the processed image to frame buffer 152 and/or directly to display controller 130 depending on algorithm conclusions or based on a default state as will be described further below, and/or image processor 120 notifying image display controller 130 that image processor 120 will write images to frame buffer 152 and/or directly to display controller 130 based on algorithm conclusions or based on a default state as will be described in more detail further below. In some embodiments, a pointer to frame buffer 152 may be passed so as to allow dynamic placement of images in memory, for example in order to indicate and update the location and number of images in memory. In one of these embodiments, the pointer may be especially relevant when there are two or more (alternate) frame buffer(s) 152. In another of these embodiments, the pointer may be especially relevant additionally or alternatively when a plurality of screens 140 is being supported, each of which corresponds to a different frame buffer 152. For example, assuming a current screen 140 displays an image which is active until a new screen 140 is activated. Continuing with the example, it is assumed that the image which will be displayed, or which a function thereof will be displayed, on new screen 140 will be stored in a frame buffer 152 that is different from the frame buffer 152 used for the current screen 140. Still continuing with the example, once the image corresponding to new screen 140 is available in new frame buffer 152, image display controller 130 may be given the address of new frame buffer 152 so as to retrieve the image corresponding to the new screen from there.

For example, in one embodiment, main processor 172 may indicate, for example via system bus 190, any of the following control indications inter-alia: indicate to image processor 120 that image processor 120 should generate a new processed image, indicate to image display controller 130 that a new processed image is being prepared (for example start and end of processing operation), provide a pointer for frame buffer 152 (received from image processor 120 or from image display controller 130) to the other module 130 or 120, and/or indicate to image processor 120 and/or image display controller 130 whether frame buffer 152 should be used or not in accordance with algorithm conclusions or based on a default state as will be explained in more detail below.

For example, in one embodiment, main processor 172 determines that a new image should be or is being generated and/or decides whether frame buffer 152 should be used based on an algorithm/default state and indicates via system bus 190 the determination and/or decision to image processor 120 or to display controller 130 which in turn indicates the determination and/or decision to the other module 130 or 120 via control channel 180. In another embodiment, for example, image processor 120 or image display controller 130 determines whether a new processed image is being generated or should be generated and/or decides based on an algorithm/default state whether frame buffer 152 should be used or not and indicates the determination and/or decision to main processor 172 via system bus 190 which in turn indicates the determination and/or decision to the other module 130 or 120 via system bus 190. Other embodiments may combine control procedures from various embodiments described above and/or different control procedures.

In some embodiments each source 170 writes each newly generated or received image to preprocessing memory 160. (For simplicity of description, a source image from a particular source 170 is termed “new”, “newly generated” or “newly received whether fully or only partially changed from the previous image from the same particular source 170). In some of these embodiments, any source 170 which has written a new image to preprocessing memory 160 indicates that a new source image is available, for example via system bus 190 and/or via control channel 182, 184, 186 (herein below a control channel between any of sources 170 and image processor 120 is referenced as 185) so that processing by image processor 120 can occur, as discussed further below. For example in one of these embodiments, a particular source 170 which has written a new image to preprocessing memory 160 may notify (indicate to) image processor 120 directly, using for example any appropriate control indication (for example protocol, signal, interrupt and/or semaphore). As another example, in some of these embodiments, a particular source 170 which has written a new image to preprocessing memory 160 may notify main processor 172 via system bus 190, in addition to or instead of directly notifying image processor 120. Continuing with the example, particular source 170 may notify main processor 172 that a newly generated or received image is available using any appropriate control indication (for example, protocol, signal, interrupt and/or semaphore), and/or particular source 170 may notify main processor 172 that a newly generated or received image is available during a periodic polling by main processor 172 of the status of sources 170. Still continuing with the example, in one of these embodiments main processor 172 may then indicate to image processor 120 (for example via system bus 190) that a new image is available. If particular source 170 is main processor 172 then in one embodiment, main processor 172 is aware of the availability of newly generated image without receiving any additional notification.

In one embodiment, if no frame buffer (152 and/or any other, for example associated with screen 140) is active then sources 170 do not necessarily notify main processor 172 and/or image processor 120 that a newly generated or received image is available. In this embodiment main processor 172 and/or image processor 120 may not need to know that a new image is available because the processing rate (i.e. how often a new processed image is generated by image processor 120) is independent of the image change rate (i.e. rate which an image is newly generated or received by any of image sources 170), as will be discussed in more detail below. In one embodiment, if a frame buffer ((152 and/or any other, for example associated with screen 140) is active then sources 170 do notify (main processor 172 and/or image processor 120) that a newly generated or received image is available because the processing rate by image processor 120 may depend at least partly on the image change rate as will be explained below. In another embodiment, sources 170 indicate (to main processor 172 and/or to image processor 120) that a newly generated or received image is available regardless of whether or not frame buffer 152 is active.

Depending on the embodiment, the timing of when image processor 120 processes the various images from sources 170 may vary. Factors relevant to the timing of the processing may include the image “change rate” which is the rate which an image is newly generated or received by any of image sources 170, and screen “display rate” which is the rate which screen 140 is illuminated (also known as refresh rate or display frame rate). The display rate may vary depending on screen 140. For example an LCD-TFT screen may display an image well at a frame rate 60 frames per second whereas to display the same image well an LCD-STN screen may require a frame rate of 90 frames per second. These frame rates are by no means binding. As another example of factors relevant to timing, in some embodiments, if frame buffer 152 or another frame buffer (for example associated with screen 140) is active (i.e. being used) and no sources images have changed, image processor does not need to process the unchanged source images to yield a processed image because the same (unchanged) processed image is stored in a frame buffer. Therefore in these embodiments with an active frame buffer, image processor 120 may process as necessary the various images in preprocessing memory 160 each time at least one new image has been generated or received by sources 170 and written to preprocessing memory 160 (i.e. the processing rate is dependent on the image change rate). In one of these embodiments with an active frame buffer, each time there is at least one new source image, image processor 120 reads any applicable source images and/or any applicable partial source images from preprocessing memory 160 which are required to generate an updated processed image. For example, main processor 172 and/or other source(s) 170 may indicate to image processor 120 (via system bus 190 and/or control channel 185) which source images and/or parts of source images to read in order to generate the updated processed image. Continuing with the example, if the display of the time changes on a cellular phone screen and the time is only a small part of the display on screen 140, in one embodiment, the background area and the time display may be read and processed by image processor 120 and the processed image generated by image processor 120 may overwrite the corresponding part of the image in frame buffer 152, thereby updating the image in frame buffer 152. In this example, display controller 130 reads a function of the (newly generated) processed image from frame buffer 152 because the image frame buffer 152 includes both the newly generated processed image combined with (part(s) of) previously generated processed image(s).

As another example, in other embodiments where frame buffer 152 or any other frame buffer is active, image processor 120 may process the various applicable (whether whole and/or partial) source images in preprocessing memory 160 required for generating an updated processed image after at least one new image has been generated and/or received by sources 170 and written to preprocessing memory 160 but before screen 140 will next be illuminated. Therefore in these other embodiments, the timing of the processing is dependent on the image change rate and on the display rate (i.e. each processed image should be ready prior to being displayed). For example, in one of these other embodiments image processor 120 may process the various applicable source images so that the lag between the processing time and the time screen 140 will next be illuminated is at least long enough to send 16 lines to screen 140. This time lag should not be construed as binding.

As another example, in some embodiments where no frame buffer (152 or any other) is active, image processor reads all images in preprocessing memory 160 (whether old or new) which are applicable to the current display and processes the read images based on the display rate of screen 140 (i.e. each processed image should be ready prior to being displayed).

In other embodiments the timing of the processing may be based at least partly on one or more other factors in addition to or instead of the image change rate and/or display rate. In some embodiments where the timing of the processing depends at least partly on the display rate, image display controller 130 or main processor 172 may provide an indication to image processor 120 regarding the time that screen 140 will next be illuminated.

In one embodiment, once image processor 120 recognizes that it is time to generate a new processed image, image processor 120 processes the source images as quickly as possible (based on the capabilities of image processor 120) to generate the processed image, thereby reducing the probability that one or more of the source images will change during the processing.

In one embodiment where frame buffer 152 is active, after generating the processed image, image processor 120 writes the processed image to frame buffer 152. Optionally, image processor 120 may indicate to display controller 130, for example via bus 190 and/or control channel 180 that an image has been generated. Display controller 130 reads the processed image or a function thereof from frame buffer 152 when display controller 130 requires the image (i.e. in time for the next screen illumination(s)). In another embodiment where frame buffer 152 is active, after generating the processed image, image processor 120 writes the processed image to frame buffer 152 and the processed image is also transferred to display controller 130 in time for the next screen illumination. For subsequent screen illumination(s) of the same processed image or a function thereof, display controller 130 reads from frame buffer 152. In another embodiment where frame buffer 152 is active, display controller 130 may request (for example via bus 190 and/or control channel 180) that image processor 120 generates a processed image in time for the next screen illumination. If a new processed image is required (for example because one of the various source images have changed or partially changed) and generation is possible, then in this other embodiment image processor 120 will generate the image and provide the processed image to display controller 120 and/or frame buffer 152. If a new processed image is not required and/or generation is not possible, then in this other embodiment image processor 120 will indicate such to display controller 130 (for example via bus 190 and/or control channel 180), and display controller 130 will read an older processed image or function thereof from frame buffer 152.

In some embodiments where frame buffer 152 is inactive but another frame buffer is active (for example associated with screen 140), then after generating the processed image, image processor 120 transfers the processed image directly to display controller 130 which in turn provides the processed image or a function thereof to another display controller for writing to the other frame buffer. For example, in one of these embodiments image processor 120 may first indicate to image display controller 130 that a new processed image is ready, for example via system bus 190 and/or control channel 180 and display controller 130 may then read the processed image from image processor 120 and transfer the processed image or a function thereof to the other display controller for writing to the other frame buffer.

In one embodiment where no frame buffer is active (for example 152 or any other) then the processed image is transferred directly from image processor 120 to display controller 130, for example display controller 130 may read the processed image from image processor 120 when display controller 130 requires the image (i.e. in time for the next screen illumination). Optionally, image processor 120 may first indicate to image display controller 130 that a new processed image is ready, for example via system bus 190 and/or control channel 180.

It should therefore be evident to the reader that in one embodiment main processor 172 may assist in controlling the timing of transfer of images between image processor 120 and image display controller 130 (directly and/or via frame buffer 152). In another embodiment image processor 120 and/or image display controller 130 may control the timing with or without the assistance of main processor 172. Depending on the embodiment, the timing may be monitored internally by the module which controls the timing or may be at least partially based on one or more external signals. For example, display controller 130 may monitor the display rate in one embodiment whereas in another embodiment, display controller may receive display rate information from screen 140. As another example, as mentioned above a signal from a particular image source 170 regarding a new source image may in some cases trigger processing by image processor 120.

The discussion above regarding timing and control of image processing and/or timing and control of the transfer of images between various modules of configuration 100, 200 or 300 (beginning with sources 170 and ending with screen 140) was provided for the sake of further illumination to the reader. The invention however does not limit the timing and the control of image processing, nor does the invention limit the timing and control of the transfer of images between various modules of configuration 100, 200 or 300. Other embodiments may therefore include different timing and/or control of the image processing and/or of the transfer of images in addition to or instead of the timing and/or control mentioned above. In these other embodiments, similar configurations, methods and algorithms as those described herein may be applied, mutatis mutandis.

It should also be evident to the reader that other functionality may be provided by any of the modules in configuration 100, 200 or 300. For example in some embodiments, main processor 172 provides additional support related to telephony and audio. Continuing with the example, for a DVD stream, main processor 172 may decode the top layers, send the video part to decompression machine 176 for decompression, decompress the audio, and ensure that the video and audio are in sync. Such functionality is known in the art and will therefore not be elaborated upon herein.

In the above discussion it was assumed that frame buffer 152 may be active or inactive. Below will be described when frame buffer 152 is active or inactive according to some embodiments of the invention. It should be understood that when frame buffer 152 is “active” in the context of the invention, frame buffer 152 is used. i.e. image processor 120 writes the processed image to frame buffer 152 (Optionally the processed image may also be transferred directly from image processor 120 to display controller 130). When frame buffer 152 is “inactive” in the context of the invention, frame buffer 152 is not used (i.e. the processed image is not written to frame buffer 152) but the processed image is transferred directly from image processor 120 to image display controller 130. Depending on the embodiment, when frame buffer 152 is inactive, frame buffer 152 may remain fully powered (although not used for image storage), may be put into “sleep mode” (aka standby mode or hibernation), or may have power removed. For example, if frame buffer 152 is a DRAM memory, there may in some cases be a special command telling the DRAM to go into sleep or power down mode. Depending on the embodiment, if frame buffer 152 is put into sleep mode or has power removed, some or all of memory 150 (besides frame buffer 152) may consequentially also be put into sleep mode or have power removed respectively.

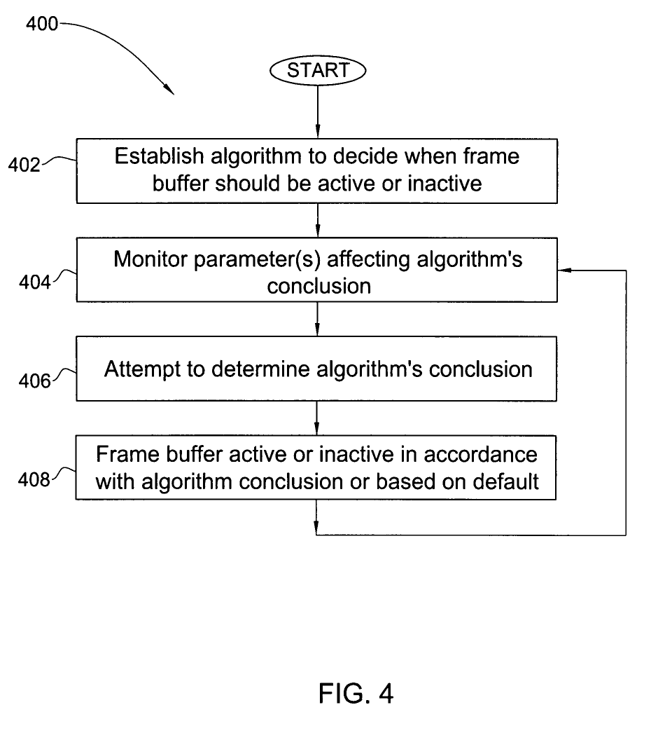

FIG. 4 illustrates a method 400 for configuring frame buffer 152 as active or inactive, according to an embodiment of the present invention. In other embodiments of the invention, fewer, more and/or different stages than those shown in FIG. 4 may be executed. In some embodiments one or more stages illustrated in FIG. 4 may be executed in a different order and/or one or more groups of stages may be executed simultaneously. Depending on the embodiment, method 400 may be applicable to any of configurations 100, 200 or 300 discussed above.

In stage 402, one or more algorithms are developed for determining whether frame buffer 152 should be active or inactive. Although depending on the embodiment there may be one or more independent algorithms or an all-inclusive algorithm, for simplicity of description the single form of algorithm is used below to include both embodiments with a single algorithm and a plurality of algorithms. Depending on the embodiment, the algorithm may be developed for execution by main processor 172, image display controller 130, image processor 120, a combination of two or more of the above, and/or any other module in configuration 100, 200 or 300. Depending on the embodiment, the developed algorithm may be adaptable over time or constant for the lifetime of configuration 100, 200 or 300. In one embodiment, the developed algorithm or part thereof is stored in memory 154.

Embodiments of the invention include an algorithm to determine whether to use or not use frame buffer 152 but the format and the content of the algorithm are not limited herein. For example in some embodiments, the developed algorithm may include a look-up table which lists the algorithm conclusion corresponding to different values of parameters, and the correct algorithm conclusion may be retrieved that corresponds to those parameter values which match or most closely match the prevailing values of the parameters as monitored in stage 404. In one of these embodiments, the look-up table may have been developed through measurements (actual and/or statistically processed) and/or from prior knowledge, for example through the use of datasheets. As another example in one embodiment, the algorithm may include one or more computations, and to determine the algorithm conclusion one or more of the monitored values of parameters may be substituted into the computations. As another example in one embodiment, the look-up table may include quantities corresponding to different values of parameters, and the algorithm may include one or more computations, and to determine the algorithm conclusion, quantities stored in the look-up table corresponding to one or more prevailing values of monitored parameters may be substituted into the computations. As another example, in one embodiment the algorithm may include one or more levels/conditions for the parameter values, and depending on whether each monitored parameter value is above or below the corresponding level (or corresponds to a predetermined condition), the algorithm conclusion may in some cases be determined. As another example, the algorithm may include a combination of any of look-up tables, computations and/or levels/conditions, in order to evaluate different parameters in the manner which is considered the most appropriate. Various embodiments of developed algorithms will be described in more detail below, however as previously explained the invention does not limit the format or content of the algorithm.

In some embodiments, the algorithm may be adjusted over time. For example, in one of these embodiments the look-up table may be improved over time, for example through additional (actual and/or statistically processed) measurements during part or all of the life of the algorithm.

In stage 404, one or more parameter(s) affecting the algorithm are monitored. For example, in one embodiment the module(s) within video module 110 which execute part or all of the algorithm also monitor(s) any parameters corresponding to that particular part or to the algorithm. In another embodiment, some or all of the parameter(s) corresponding to part or all of the algorithm may be monitored by module(s) of FIG. 1, 2, or 3 which do not execute that particular part or the algorithm, and the monitoring module(s) may indicate the status of the monitored parameter(s) to the executing module(s), for example via system bus 190, control channel 180 and/or any other control channel (for example 185).

In stage 406, the executing module(s) within video module 110 attempt to determine a conclusion of the algorithm (i.e. based on the prevailing values of the monitored parameter(s) and the content of the algorithm, the executing module(s) attempt to determine whether frame buffer 152 should be active or inactive). In one embodiment, the executing module(s) may in stage 406 refer to a look-up table generated in stage 402 and select from the look up table the conclusion of the algorithm (or a partial conclusion) whose corresponding values match (or mostly closely match) the prevailing values of the monitored parameters. In another embodiment, alternatively or additionally, the executing module(s) may in stage 406 refer to pre-established levels/conditions of one or more of the parameters in an attempt to determine the conclusion (of the algorithm or a partial conclusion). In another embodiment, alternatively or additionally, the executing module(s) may in stage 406, look up quantities in a look-up table, such as for example previously measured or known power consumptions corresponding to the values of one or more of the monitored parameters values and calculate based on the retrieved power consumptions whether a power based decision would be for frame buffer 152 to be active or inactive. In another embodiment, the executing modules may in stage 406 instead or in addition, determine an algorithm conclusion based on monitored parameter values without necessarily accessing a previously developed look-up table, for example by using one or more monitored parameter values in appropriate computations.

In stage 408, frame buffer 152 is (or remains) activated or deactivated based on the algorithm conclusion and/or based on a predefined default state. Refer above to the discussion regarding possible effect(s) of an active or an inactive frame buffer 152 on the operation of various modules of configuration 100, 200 or 300 and how various modules in configuration 100, 200 or 300 may be made aware of the active or inactive state of frame buffer 152.

If no decision is made based on the algorithm, if the decision is inconclusive, and/or if the algorithm conclusion is that the default setting is appropriate, a default setting for frame buffer 152 may be set in stage 408. The default setting for frame buffer 152 may vary depending on the embodiment. For example in one embodiment the default setting may be an inactive (deactivated) frame buffer. In another embodiment, the default setting may be an active (activated) frame buffer. In another embodiment, the default setting may be to retain the frame buffer in the current active or inactive state or to change the frame buffer to the opposite of the current active or inactive state.

In some embodiments the algorithm conclusion that frame buffer 152 should be active or inactive as determined in stage 406 depends at least partly on a comparison of whether power consumption is higher for an active frame buffer 152 or for an inactive frame buffer 152. In some of these embodiments, rather than comparing whether the total power consumed for an active or inactive frame buffer 152 is higher, there may be a comparison whether the extra power consumed with an active or inactive frame buffer 152 is higher. For example in one of these embodiments, it may be assumed that if frame buffer 152 is active, there is an extra read by image display controller 130 from frame buffer 152 and an extra write to frame buffer 152 by image processor 120 which would otherwise not be required, each time screen 140 is illuminated (or each time after the first that screen 140 is illuminated, if the processed image is also transferred to image display controller 130 in parallel to being stored in frame buffer 152). Continuing with this embodiment of comparing extra power requirements, it may be assumed that if there is no active frame buffer (152 or elsewhere), image processor 120 is required to read and process source images each time screen 140 is illuminated, regardless of whether any source image has changed. Because even with an active frame buffer (152 or elsewhere), image processor 120 would be required to read and process source images when at least one image has changed (see above) it may be assumed that the extra power required when there is no active frame buffer is the power required for reading and processing images when no source images have changed (hereinbelow unchanged source images refers to a situation where no source images have changed).

Table 1 shows one example of the embodiment for comparing extra power requirements. The example in table 1 is provided for further illustration to the reader and should therefore not be considered binding. For simplicity of explanation, the comparison shown in table 1 below refers to power consumptions deriving from activity and assumes that frame buffer 152 remains fully powered or that the power saved by putting frame buffer 152 to sleep or removing power is negligible compared to the power consumptions deriving from activity. The extra power requirements with or without the frame buffer for this example are summarized in table 1:

TABLE 1
extra power consumption comparison according to one example

| | Without |
|---|---|
| With Frame Buffer 152 - extra | frame buffer 152 (or any other |
| power required | frame buffer) - extra power required |
| Power required to write to and to | Power required to read images from |
| read from frame buffer. | preprocessing memory and to process |
| Power required to refresh data in | those images when source images are |
| frame buffer (assuming | unchanged. |
| Dynamic RAM). | This includes the power of the |
| For all the above, this includes the | memory, memory controller, bus |
| power of the memory, memory | and signal drivers, |
| controller, bus and signal | etc. |
| drivers, etc. | |

Continuing with an explanation of an embodiment where extra power requirements are compared, if the extra power required with an active frame buffer 152 is less than with frame buffer 152 as inactive, frame buffer 152 should be active. Otherwise if the extra power required with frame buffer 152 in the inactive state is less than with frame buffer 152 in the active state, frame buffer 152 should be inactive.

Depending on the embodiment, a comparison of power consumption (whether for total power, extra power, etc) may be based on actual power consumptions for an active or inactive frame buffer 152 which correspond to the prevailing values of the monitored parameters, or may be determined based on prevailing values of the monitored parameters (without necessarily delving into power consumptions) by assuming how different values of the monitored parameters reflect power requirements for an active or inactive frame buffer 152.

Assume for the sake of example that the developed algorithm depends at least partly on actual power consumptions. Actual power consumption may vary depending on the particular implementation, for example, depending on type of memory used for frame buffer 152, which of configurations 100, 200, or 300 is used, the voltage(s) used, the length of wiring used, the packaging used, and/or any other factors. Therefore in one of these embodiments, a developer in stage 402 may have measured the power consumption (whether for total power, extra power, etc) in the current implementation for different monitored parameter values or for different combinations of monitored parameter values when frame buffer 152 is active versus inactive, and developed a look-up table listing the a power based decision, if any, corresponding to the different parameter value(s). Depending on the embodiment, the developed power based decision may be based on an assumption that frame buffer 152 remains powered, is put into sleep mode or is powered down when inactive. In another of these embodiments, a developer may have in stage 402 measured the power consumption in the current implementation for different values of one or more monitored parameters and listed the corresponding power consumptions in the look-up table (where in some cases the power consumption quantities may vary depending on whether frame buffer 152 remains powered, is put into sleep mode or is powered down when inactive). As mentioned above, in one embodiment, measurements may continue to be performed during the life of the algorithm and the look-up table may be adapted accordingly.

In other embodiments, non-power related considerations may override a conclusion based on a power consumption comparison and/or non-power related considerations may be considered along with power considerations when attempting to decide in stage 406 whether frame buffer 152 should be active or inactive.

An explanation of some parameters any of which may be monitored in stage 404 are now provided, assuming that any power comparison reflects the extra power consumed with an active or inactive frame buffer 152. In the discussion below, for simplicity's sake, it is assumed that the same image (processed image) that is written to frame buffer 152 is read from frame buffer 152 (rather than a function of the processed image being read).

In one embodiment, the presence or non-presence of an active display controller and frame buffer (other than display controller 130 and frame buffer 152) is a parameter which is monitored in stage 404. For example, there may or may not be an active display controller and an active associated frame buffer associated with the currently active screen 140 configured to receive and/or store images from video module 110. If there is an active associated display controller and active associated frame buffer (or more than one), then there is no need for image processor 120 to process source images when no source images have changed because screen 140 may receive the unchanged processed image from the active associated frame buffer. Therefore the power associated with unnecessary processing is negligible. However, writing to and reading from frame buffer 152 would require power. The presence or non-presence of an active associated frame buffer may be monitored for example in one embodiment by main processor 172 and/or image display controller 130. For example there may be an indication from screen 140 regarding the presence or non-presence of an associated frame buffer, or main processor 172 may know based on the configuration of screen 140 whether there is an associated frame buffer or not.

In one embodiment, the rate of source image change (“change rate” i.e. the rate that at least one source image changes, not necessarily the same source image always) versus the display rate is a parameter which is monitored in stage 404. If the change rate is at least as fast as the display rate, then whenever screen 140 is refreshed, the processed image to be displayed is necessarily new. Therefore theoretically there should be no unnecessary reading and processing of unchanged images and the power consumed by reading and processing of unchanged images is theoretically negligible. However, writing to and reading from frame buffer 152 would require power. In one embodiment, main processor 172, image processor 120 and/or display controller 130 monitors the rate of source image change versus the display rate.

In one embodiment, the change rate and/or display rate are individually monitored in stage 404. In one embodiment, the sum of the change rate and display rate reflect the rate at which an active frame buffer 152 is written to (change rate) and read from (display rate), while the difference between the display rate and the change rate reflects the rate that unchanged source images are read (for an inactive frame buffer 152). In one embodiment, main processor 172, image processor 120 and/or display controller 130 monitors the rate of source image change and/or display rate.

In one embodiment, the number (i.e. quantity) of source images may be a parameter that may be monitored in stage 204. For example, if there is only one source image which requires negligible processing, then even if the source image has not changed, reading and processing the unchanged source image may in one embodiment be estimated to require approximately the same amount of power as writing and reading a processed image to and from frame buffer 152. However, continuing with the example, if there are multiple images, then if the source images have not changed, reading and processing the unchanged source images in one embodiment may be assumed to require more power than writing and reading a processed image to and from frame buffer 152. Depending on the embodiment, the number of unchanged source images may be monitored, or the number of source images corresponding to any processed image may be monitored based on the assumption that the number of source images contributing to the processed image is similar whether source images are unchanged or not. In one embodiment sources 170, main processor 172, and/or image processor 120 monitors the number of source images.

In one embodiment, the amount of required processing on the source image(s) may be a parameter that may be monitored in stage 204. For example if there is a lot of required processing, then if the source image(s) have not changed, processing the unchanged source image(s) would be expected in one embodiment to require more power than writing and reading a processed image to and from frame buffer 152. Depending on the embodiment, the amount of processing corresponding to unchanged source image(s) may be monitored, or the amount of processing corresponding to any processed image may be monitored based on the assumption that the amount of processing is similar whether the source images are unchanged or not. In one embodiment, image processor 120 and/or main processor 172 monitor the amount of processing.

In some embodiments, the number of bits per pixel may be a parameter that is monitored in stage 204. In these embodiments it may be assumed that more power is required when the number of bits per pixel is increased. In one of these embodiments, the number of bits per pixel may be determined for unchanged source images from sources 170 and/or determined for the processed image provided to display controller 130. For example, if the number of bits per pixel of the processed image is compared to the number of bits per pixel of the unchanged source images, and the number of bits per pixel of the processed image is larger, then it may be assumed, for example, that it would require less power for image processor 120 to read the unchanged source images from preprocessing memory 160 than for a processed image to be written to and read from frame buffer 152. Depending on the embodiment, the number of bits per pixel of unchanged source images may be monitored, or the number of bits per pixel of source images corresponding to any processed image may be monitored based on the assumption that the number of bits per pixel of source images is similar whether the source images are unchanged or not. In one embodiment, sources 170, image processor 120 and/or main processor 172 monitor the number of bits per pixel.

In some embodiments the number of pixels in an image may be a parameter that is monitored in stage 204. In these embodiments it may be assumed that more power is required when the number of pixels per image is increased. In one of these embodiments, the number of pixels per image may be determined for the unchanged source images from sources 170 and/or determined for the processed image provided to display controller 130. For example, if the number of pixels per image of the processed image is compared to the number of pixels per unchanged source image, and the number of pixels per image of the processed image is larger, then it may be assumed, for example, that it would require less power for image processor 120 to read the unchanged source images from preprocessing memory 160 than for a processed image to be written to and read from frame buffer 152. Depending on the embodiment, the number of pixels per unchanged source images may be monitored, or the number of pixels per source images corresponding to any processed image may be monitored based on the assumption that the number of pixels per source images is similar whether the source images are unchanged or not. In one embodiment, sources 170, image processor 120 and/or main processor 172 monitor the number of pixels per image.

In some embodiments, the ability to time the processing so that a processed image is generated at a suitable time for the processed image to be displayed on screen 140 may be a parameter to be monitored in stage 204. For example in one of these embodiments the level of synchronization between the rate of image change and the display rate may be monitored. For example, if the power to read and process unchanged images is less than the power to write to and read from frame buffer 152, theoretically it may be worthwhile for frame buffer 152 to be inactive. However, if configuration 100, 200, or 300 is unable to time the generation of the processed image properly, then in one embodiment a frame buffer 152 may be used in order to overcome timing problems. In some cases, if image processor 120 can not time the generation of the processed image correctly in order to be ready for display there may be extra reading and processing of source images in order to ensure correct timing which would require extra power and in this case, the timing problem may be reflected in a power consumption comparison. However, in other cases, the timing problem may not affect the power consumption but may still be a consideration which may override a decision based on a power consumption comparison or which should be considered along with power consumption related considerations when making the decision. For example in one embodiment, it may be initially assumed that configuration 100, 200, or 300 can time the generation of the processed image properly and that frame buffer 152 should be active or inactive based on power-related considerations. Continuing with the example, if however during monitoring of operation with an inactive frame buffer 152 it is demonstrated that timing is a problem (which cannot be fixed), then frame buffer 152 may in this embodiment be rendered active (assuming there is no active frame buffer associated with screen 140). In one embodiment, main processor 172, image processor 120 and/or display controller 130 monitors the timing.

Similarly to timing considerations, there may be other operational (non-power) considerations monitored in stage 204 that may apply to a particular embodiment which may over-ride any conclusions based on a power consumption comparison or which should be considered along with power consumption considerations when attempting to determine whether frame buffer 152 should be active (activated) or inactive.

Based on the particular algorithm, any of the monitored parameters discussed above, and perhaps other factors, a decision may in some cases be made to use or not use frame buffer 152 in stage 208. The decision based on the algorithm may be made for example by main processor 172, image processor 120, image display controller 130, a combination of two or more of the above, and/or any other module in configuration 100, 200, or 300. In one embodiment, main processor 172, image processor 120, image display controller 130 a combination of two or more of the above, and/or any other module in configuration 100, 200, or 300 may be responsible for deciding that frame buffer 152 should instead have the default setting. The decided active or inactive state of frame buffer 152 may be relevant for example to any of the following inter-alia: image processor 120 (so as to write or not write to frame buffer 152 and/or for example to control/provide timing to modules in configuration 100, 200, or 300), image display controller 130 (so as to read or not read from frame buffer 152 and/or for example to control/provide timing to modules in configuration 100, 200, or 300) and/or main processor 172 (for example to control the power state of frame buffer 152 (powered, sleep, or unpowered) and/or for example to control/provide timing to modules in configuration 100, 200, or 300). For example, system bus 190, control channel 180, and/or any other control channel (for example 185) may be used to convey monitored parameter values to other modules in configuration 100, 200, or 300, convey the algorithm concluded frame buffer state/default frame buffer state to other modules in configuration 100, 200, or 300 and/or to change the power state of frame buffer 152.

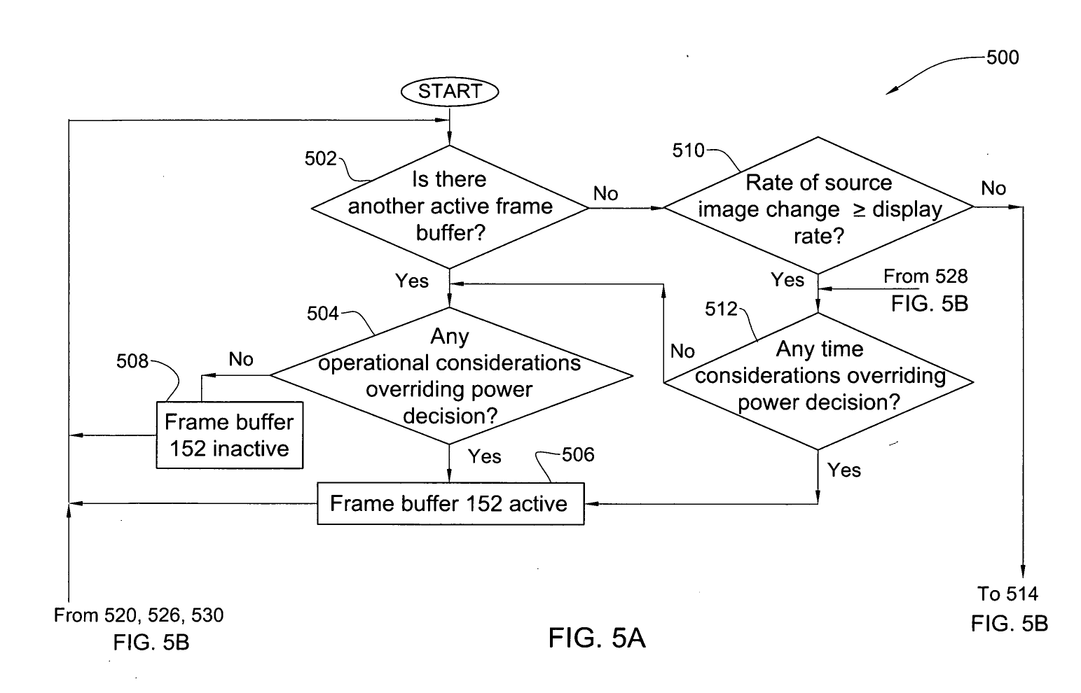

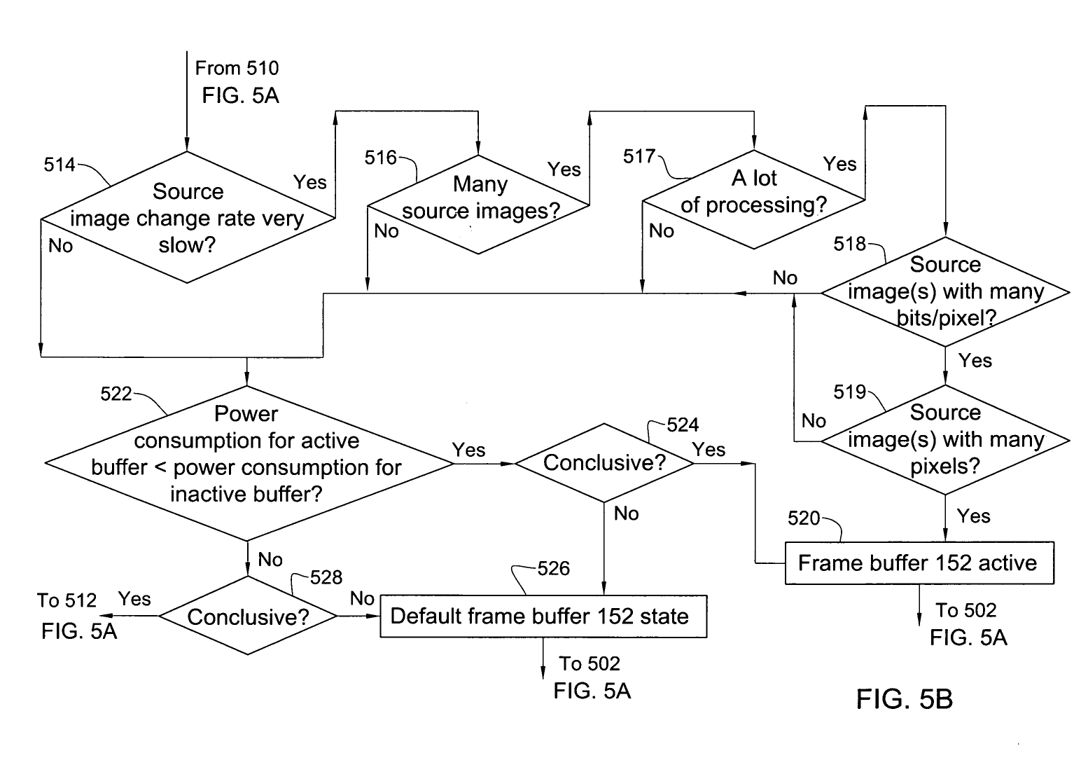

FIG. 5 is a flowchart of a method 500 for determining whether frame buffer 152 should be active or inactive, according to an embodiment of the present invention. Method 500 describes stages 404, 406 and 408 in more detail for a possible algorithm and therefore it should be understood that in other embodiments, other methods of implementing stages 404, 406 and 408 may be executed instead of or in addition to method 500. In other embodiments of the invention, fewer, more and/or different stages than those shown in FIG. 5 may be executed. In some embodiments one or more stages illustrated in FIG. 5 may be executed in a different order. For example, in one embodiment any of the (diamond shape) decision stages may be re-executed when a monitored parameter which affects the decision changes value. In some embodiments, one or more groups of stages may be executed simultaneously and/or a group of stages illustrated in FIG. 5 as being executed simultaneously may instead have the stages executing sequentially.

In the described embodiment, method 500 includes a two staged approach, first determining based on comparing values of certain monitored parameters to predetermined levels/conditions whether frame buffer 152 should be active or inactive and if more analysis is required then moving towards a second quantitative analysis stage.

In stage 502, as part of a determination whether an active frame buffer 152 causes configuration 100, 200 or 300 to consume less or more power, it is determined whether there is at least one other active frame buffer, for example associated with screen 140, where images exiting from video module 110 may be stored. If there is another active frame buffer (yes to stage 502), then using frame buffer 152 would seemingly be redundant. For example, if the comparison of table 1 is made, it is evident that there is no need for image processor 120 to read and process unchanged source images (because the unchanged processed image is stored in the other active frame buffer) so extra power is not required for an inactive frame buffer 152 however extra power would be consumed by writing to and reading from an active frame buffer 152. This determination in stage 502 may be thought of in one embodiment as a comparison of the number of other frame buffers (value of monitored parameter) to a predefined level of 1, and if the monitored value is at least equal to 1 then the power based decision is to have frame buffer 152 as inactive. If there are no operational considerations which override the power-based decision to have frame buffer 152 in the inactive state (no to stage 504), then frame buffer 152 remains inactive or becomes inactive in stage 508. If there are operational considerations which override the power decision (yes to stage 504) then frame buffer 152 remains active or becomes active in stage 506. In one embodiment, each time a different screen 140 becomes active, it is determined (stage 502) if the currently active screen has an associated frame buffer and if the current screen has an associated frame buffer, a decision is made to render inactive frame buffer 152 (or keep frame buffer 152 inactive) providing there are no overriding operational decisions.

Assuming there is no other active frame buffer (no to stage 502), then in stage 510 as part of a determination whether an active or inactive frame buffer 152 causes configuration 100, 200, or 300 to consume less power, it is determined whether the rate of source image change is at least as fast to the display rate. If the rate of source image change is at least as fast (yes to stage 510), then seemingly there would be no unnecessary reading and processing of unchanged source images (because the source images change more quickly than the refresh rate) and that reading and writing from an active frame buffer 152 would consume more power. In one embodiment, the determination in stage 510 may be considered as a comparison of the values of a monitored parameter defined as the rate of source change minus display rate to a predefined level of zero and if the difference is at least equal to zero then the power-based decision is to have frame buffer 152 in the inactive state.

However there may be timing considerations that override the power-based decision (yes to stage 512). For example, it may be difficult for image processor 120 to time the generation of the processed image for presentation on screen 140 at the correct time. Alternatively or additionally there may be other operational considerations which make it infeasible to render or maintain as inactive frame buffer 152 (yes to stage 304). If neither operational nor timing considerations override the power-based decision, then frame buffer 152 remains inactive or is rendered inactive in stage 508.

For example, in one embodiment assuming no overriding operational considerations, if the rate of source image change is at least as fast as the display rate and the synchronization between the two rates is high (for example a processed image is generated by image processor 120 so that there is an appropriate lag until image display controller 130 requires the processed image for display on screen 140), then it may be assumed that any unnecessary processing of unchanged images due to incorrect timing would be minimized and that the power based decision may be relied upon. Therefore in this example it may be assumed that the power used during any unnecessary processing of unchanged images would be less than the power using in writing to and reading from frame buffer 152 and therefore frame buffer 152 should be rendered or remain inactive (stage 308).

If operational and/or timing considerations override the power decision, then frame buffer 152 remains active or is rendered active (stage 506).

If the rate of source image change is slower than the display rate, then there are many times that the screen is illuminated with the same image as before (i.e. unchanged processed image). Therefore it would have to be considered how much power is required to read and process the unchanged source images versus writing and reading a processed image to and from frame buffer 152. The comparison may depend for example on the number of source images, how much processing is required, how much slower the rate of source image change is than the display rate, the number of bits per pixel, the number of pixels per image and/or any other relevant factors.

Therefore method 500 continues with considering values of other monitored parameters in stage 514, 516, 517, 518, and 519 as part of a determination whether an active frame buffer 152 causes configuration 100, 200, or 300 to consume less or more power. These determinations consider whether it is very likely that having an active frame buffer would be the correct power-based decision by comparing monitored characteristics (values) of the source images (or unchanged source images) to predetermined levels. In the description below, of stages 514, 516, 518, and 519 it is assumed that the monitored characteristics are similar for changed or unchanged source images, but in another embodiment the characteristics may be monitored exclusively for unchanged source images.

If it is determined in stages 514, 516, 517, 518, and 519 that the rate of source image change is very slow (for example below a predetermined level), that there are many source images (for example that the number of source images exceed a predetermined level), that a lot of processing is required on the source images (for example the number of processing operations exceed a predetermined level), that the number of bits per pixel for the source images is large (for example greater than a predetermined level), and that the number of pixels for the source images is large (for example greater than a predetermined level) then in the described embodiment, it is assumed that writing to and reading from an active frame buffer 152 would consume less power than the reading and processing of unchanged source images. Therefore stage 520 is executed, rendering frame buffer 152 as active or maintaining frame buffer 152 as active. The predetermined levels for any of stages 514, 516, 517, 518, and 519 may vary depending on the embodiment. For example in one embodiment it may be assumed that there is a lot of processing if there is more than 1 OSD and the OSD covers the whole image. This example should not be considered binding. For example, if predetermined levels are set more stringently, then it is less likely that stage 520 will be performed than if thresholds are set less stringently. Continuing with the example if in one embodiment it is considered that there are many source images for 4 or above rather than 2 or above, it is less likely that stage 520 will be performed. (It should be understood that “4” and “2” are arbitrary and should not be considered binding on the invention).

In the algorithm described thus far with reference to FIG. 5, the criteria for deciding to render or to maintain frame buffer 152 as inactive are more stringent than the criteria for deciding to render or maintain frame buffer 152 as active. For example, it is assumed that timing considerations and/or other operational considerations may override a power-based decision to render or maintain frame buffer 152 as inactive but not a power-based decision to render or maintain frame buffer 152 as active. In other embodiments, the criteria for deciding to render or maintain as active frame buffer 152 may be as stringent or more stringent than the decision to deactivate/maintain as inactive. For example, timing considerations and/or other operational considerations may additionally or alternatively override a power-based decision to render or maintain frame buffer 152 as active, and in these embodiments prior to stage 520 (active frame buffer), it is determined whether there are any operational and/or timing considerations overriding the power-based decision, and if yes the frame buffer is rendered or remains inactive.

Assuming that the answer to at least one of stages 514, 516, 517, 518, or 519 is no (i.e. change rate not slower than predetermined level, number of source images not above predetermined level, amount of processing not above a predetermined level, number of bits per pixels in source images not above a predetermined level, and/or number of pixels per source images not above a predetermined level), then in stage 522, a quantitative analysis of the amount of power consumed by writing to and reading from an active frame buffer 152 versus the amount of power consumed by reading and processing unchanged images is performed.

For example in one embodiment stage 522 may include referring to a look-up table to match prevailing values of monitored parameters to a power based decision entry in the table, thereby retrieving the corresponding power based decision of whether frame buffer 152 should be active or not. As another example, in one embodiment stage 522 may include referring to a look-up table to retrieve power consumption measurements corresponding to prevailing values of the monitored parameters and then using the retrieved measurements to make a power based decision.

As another example, in one embodiment stage 522 can include a computation using monitored parameter values which reflect power requirements. For example a possible computation in stage 522 which takes into account the number of source images, the number of bits per pixel and the number of pixels per image may have the following form:

$$( \# bits \text{/} pixel \times \# pixels / image\_forprocessed \_image ) \times ( change\_rate + display\_rate ) < ( ( {\sum }_{i = 1}^{nsourceimages} ( \# bits \text{/} pixel \times \# pixels \text{/} {image}_{i} ) \times ( display\_rate - change\_rate ) \times k )$$

In the above equation, if the left hand side is less than the right hand side then the power based decision is to have the frame buffer in the active state. Looking at the left hand side of the equation which represents the extra power consumed in the active state, if frame buffer 152 is active then the processed image (represented by the number of bits per pixel multiplied by the number of pixels per image) is written at the change rate to frame buffer 152 and read from the frame buffer 152 at the display rate. Looking at the right hand side of the equation which represents the extra power consumed in the inactive state, the number of bits per pixel is multiplied by the number of pixels per image for each of the source images and the total for all source images is summed. If frame buffer 152 is inactive, then image processor 120 must read the source images also when source images are unchanged in order to illuminate the display. The reading when source images are unchanged is at a rate equal to the display rate—change rate. The “k” on the right hand side of the equation represents the amount of processing of the source images and therefore the summation is also multiplied by “k”. The value of “k” may be determined for example based on measurements, data sheets, and/or calculations. The above equation was presented for further illumination to the reader and should not be considered binding on the invention. For example, in other embodiments, additional, less or different factors than in the above equation may be included in a computation. In one of these embodiments, for example, the reduction in power assuming that frame buffer 152 is put to sleep or has power removed may be a factored in a computation.

In another embodiment, stage 522 may be performed earlier in method 500. For example consultation of a look-up table may be used instead of method 500, or at any time after stage 502. As another example the equation presented above or any other computation may be executed after stage 510 (i.e. with stages 514 to 519 omitted).

If the power consumed by writing to and reading from frame buffer 152 is conclusively lower (yes to stages 522 and 524) then stage 520 is performed (frame buffer 152 remains or is rendered active). If the power consumed by frame buffer 152 is lower but not conclusively (for example not by a predetermined gap which may vary depending on the embodiment), then in stage 526, frame buffer 152 is set to the default state. If the power consumed by writing to and reading from frame buffer 152 is conclusively higher (no to stage 522 and yes to stage 528), then if there are no overriding timing (stage 512) and no overriding operational considerations (stage 504), frame buffer 152 is rendered or remains inactive (stage 508). If there are overriding timing (stage 512) and/or operational considerations (stage 504), then frame buffer 152 remains active or is activated (stage 506). If the power consumed by frame buffer 152 is higher but not conclusively (for example not by a predetermined gap which may vary depending on the embodiment), then in stage 530, frame buffer 152 is set to the default state.

In another embodiment, if the answer to at least one of stages 514, 516, 517,518 and 519 is no (change rate not slower than predetermined level, number of source images not above predetermined level, amount of processing not above a predetermined level, number of bits per pixels in source images not above a predetermined level, and/or number of pixels per source images not above a predetermined level), then rather than performing a detailed quantitative analysis, frame buffer 152 is set to the default state.

After a decision whether to render/keep active, or render/keep inactive frame buffer 152 is reached in accordance with method 500, then in one embodiment method 500 iterates back to monitoring parameters, for example beginning with stage 502. For example, if screen 140 has changed since the last execution of stage 502, the answer to stage 502 may be different. As another example, if the rate of source image change and/or display rate have changed since the last iteration of stage 510, then the answer to stage 510 may be different. Depending on the embodiment the monitoring of the various parameters may be continuous or may be periodic. Depending on the embodiment, the monitoring of certain parameters may be more frequent than others. For example, in one embodiment, monitoring may include assuming that all parameter values are unchanged unless otherwise indicated. Continuing with the example, assuming main processor 172 executes the algorithm of method 500, main processor 172 may assume that screen 140 is the same screen with the same characteristics unless indicated otherwise for example by screen 140 or display controller 130, that the rate of source image change is unchanged unless indicated otherwise for example by any of sources 170 or image processor 120, that the display rate is unchanged unless indicated otherwise for example by display controller 130 or screen 140, that the number of source images is unchanged unless indicated otherwise for example by any of sources 170 or image processor 120, that the amount of processing is unchanged unless indicated otherwise for example by image processor 120, that the number of bits per pixel and pixels per image is unchanged unless indicated otherwise for example by any of sources 170 or image processor 120, and that timing and/or operational considerations are unchanged unless indicated otherwise by any of modules of configuration 100, 200, or 300. Continuing with the example, in another embodiment, main processor 172 knows of any changes to parameter values and informs other module(s) in configuration 100, 200 or 300 of the changes and/or configures other module(s) in configuration 100, 200, 300 accordingly.

In some embodiments, the methods and systems described above reduce power consumption compared to a system which does not allow both an active and an inactive state for frame buffer 152. The power consumption may be reduced for example by reducing power consuming operations corresponding to frame buffer 152 being in the active and/or inactive state and/or optionally by having an inactive frame buffer 152 put into sleep mode or powered down. In some embodiments, the reduction of power consumption by optimizing the state of the frame buffer (active or inactive as described above) may be especially advantageous for electronic systems including configuration 100, 200 or 300 where available power is a limited quantity. For example in one of these embodiments an electronic system with a battery/ies (rechargeable or not) has a limited amount of power available until the battery/ies is replaced or recharged. In some cases, increasing the length of time that battery/ies may be used prior to being replaced or recharged may provide an especially competitive advantage for a mobile or handheld electronic system, where consumers prefer to recharge or replace batteries as infrequently as possible but size limitations for the electronic system may in turn limit the size of the battery/ies that can be used for the system.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been shown and described with respect to particular embodiments, it is not thus limited. Numerous modifications, changes and improvements within the scope of the invention will now occur to the reader.

1. A method of selectively using a frame buffer, comprising:
processing at least part of at least one image from at least one source, yielding a processed image; and
storing or not storing said processed image in a frame buffer, based on at least one consideration;
wherein regardless of whether said processed image is stored or not stored in said frame buffer, said processed image or a function thereof is displayed on a screen.

2. The method of claim 1, wherein at least one of said considerations is a power based consideration, said method further comprising:
attempting to determine whether an active or an inactive state of said frame buffer reduces power consumption;
if said determination is that an active state for said frame buffer reduces power consumption, then deciding that said power based consideration is in favor of storing said processed image in said frame buffer; and
if said determination is that an inactive state for said frame buffer reduces power consumption, then deciding that said power based consideration is against storing said processed image in said frame buffer.

3. The method of claim 2, wherein said attempting to determine whether an active state or an inactive state for said frame buffer reduces power consumption includes:
determining whether there is another frame buffer where said processed image or a function thereof will be stored, and if there is, then determining that power consumption is reduced if said frame buffer is inactive.

4. The method of claim 2, wherein said attempting to determine whether an active state or an inactive state for said frame buffer reduces power consumption includes:
determining a change rate of said at least one source image and comparing said change rate with a display rate of said screen; and
if said change rate is at least as fast as said screen display rate, then determining that power consumption is reduced if said frame buffer is inactive.

5. The method of claim 2, wherein said attempting to determine whether an active state or an inactive state for said frame buffer reduces power consumption includes:
comparing power consumed in writing said processed image to said frame buffer and reading said processed image or a function thereof from said frame buffer with power consumed in reading unchanged source images from memory and processing said unchanged source images to yield said processed image, and if said power consumed in writing and reading from said frame buffer is less, then determining that power consumption is reduced if said frame buffer is active.

6. The method of claim 2, wherein said attempting to determine whether an active state or an inactive state for said frame buffer reduces power consumption includes consulting a look-up table.

7. The method of claim 2, further comprising:
determining whether there are any considerations unrelated to power consumption which affect a decision to store or not store said processed image in said frame buffer; and
if there are no other considerations unrelated to power consumption, then storing or not storing said processed image in said frame buffer dependent on said power-based consideration.

8. The method of claim 1, further comprising: monitoring at least value of at least one parameter which affects at least one of said considerations, said at least one parameter selected from a group comprising: presence of another active frame buffer configured to store said processed image or a function thereof, change rate of said at least one source image, screen display rate, quantity of said at least one source image, amount of processing required for yielding said processed image, bits per pixel, pixels per image, and synchronization between change rate of said at least one source image and display rate of said screen.

9. The method of claim 8, further comprising: if at least one value of at least one monitored parameter changes, storing or not storing at least one subsequent processed image in said frame buffer, based on at least one consideration which takes into account said changed value.

10. The method of claim 1, wherein at least one of said considerations is a timing consideration.

11. The method of claim 1, wherein at least one of said considerations includes a default state for said frame buffer.

12. The method of claim 1, further comprising:
if said processed image is not stored in said frame buffer putting said frame buffer in sleep mode.

13. A method of selectively using a frame buffer, comprising:
monitoring at least one parameter affecting an outcome of an algorithm for determining whether or not a frame buffer is to be written to during provision of images to a screen;
attempting to determine an outcome of said algorithm based on at least one value of said at least one monitored parameter; and
deciding based on said algorithm conclusion or based on a default state for said frame buffer whether or not said frame buffer is to be written to during provision of images to said screen.

14. The method of claim 13, further comprising:
after deciding whether or not to write to said frame buffer, determining a different outcome for said algorithm based on at least one changed value of at least one monitored parameter; and
changing a configuration of said frame buffer so as to write a subsequent image to said frame buffer if said frame buffer had previously been inactive, or so as to not write a subsequent image to said frame buffer if said frame buffer had previously been active.

15. The method of claim 13, wherein said outcome of said algorithm is at least partly dependent on whether power consumption is reduced when images are stored or not stored in said frame buffer.

16. The method of claim 13, further comprising: developing said algorithm.

17. The method of claim 16, wherein said developing includes measuring power consumption for different values of at least one of said monitored parameters.

18. A system for selectively using a frame buffer, comprising:
a frame buffer;
an image processor configured to selectively write to said frame buffer during provision of images to a screen; and
an image display controller configured to selectively read from said frame buffer, during provision of images to a screen.

19. The system of claim 18, further comprising: a screen, wherein if said screen includes an associated frame buffer, said image processor is configured to not write to said frame buffer, and said image display controller is configured to not read from said frame buffer.

20. The system of claim 18, further comprising: at least one image source, wherein said image processor is further configured to process images or parts thereof provided by said at least one image source to generate images which are selectively written to said frame buffer.

21. The system of claim 20, further comprising: memory for storing said images provided by said at least one image source.

22. The system of claim 21, wherein said memory includes an on screen display OSD buffer.

23. The system of claim of claim 20, wherein at least one of said image sources is a main processor.

24. The system of claim 18, further comprising at least one alternate frame buffer, wherein said image processor is configured to alternate writing of images among said frame buffer and said at least one alternate frame buffer.

25. The system of claim 18, further comprising: means for determining whether it is preferable that said image processor write or not write to said frame buffer.

26. The system of claim 25, wherein said means includes means for monitoring a value of a parameter or receiving a value of a monitored parameter and using said value in said determining.

27. The system of claim 25, wherein said preference is at least partly based on a power consumption comparison between an active state and an inactive state of said frame buffer.

28. The system of claim 25, wherein said means includes: a main processor, said main processor further configured to indicate to said image processor whether or not to write to said frame buffer.

29. The system of claim 25, wherein said means includes: said image processor.

30. The system of claim 25, wherein said means includes: said image display controller.

31. The system of claim 18, further comprising a control channel between said image processor and said image display controller.

32. The system of claim 31, wherein said display controller is further configured to request via said control channel from said image processor that said image processor generates a new image.

33. The system of claim 31, wherein said image processor is further configured to indicate via said control channel to said display controller that a new image is being prepared.

34. The system of claim 31, wherein said display controller is further configured to indicate via said control channel to said image processor whether or not to write to said frame buffer.

35. The system of claim 31, wherein said image processor is further configured to indicate via said control channel to said display controller whether or not to read from said frame buffer.
